(19) United States
(12) Patent Application Publication
(10) Pub. No.: US 2009/0315810 A1
(43) Pub. Date: Dec. 24, 2009

(54) INFORMATION PRESENTATION DEVICE

(75) Inventor: Martijn KUIKEN, Az Veendam (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/142,218

(22) Filed: Jun. 19, 2008

(51) Int. Cl. G09G 3/00

(52) U.S. Cl. 345/31

(57) ABSTRACT

The present invention relates to a method and a device for presentation of list type information on a display. The method controls the information to be presented on the display, and comprises obtaining information to be presented on the display, presenting information on the display, and detecting a rotational motion around an axis of rotation of an information presentation device, providing the presented information on the display in dependence of the detected rotational motion, such that information can be shifted out from the display and shifted in to the display.

### TECHNICAL FIELD

The present invention relates in general to a method and a device for presentation of information and in particular to a method and a device for presentation of information in dependence of changes in rotation of an information presentation device.

### BACKGROUND

Information presentation units, such as displays, are comprised in a large variety of portable electronic devices, not to mention mobile phones.

The size of mobile phones has roughly decreased over the past years, whereas the size of the information presentation units has increased.

An alternative to presenting information on one large display, presenting information on two or more displays has also been used, for example on either side on a mobile phone.

However, there is a demand for even larger displays or screens for presentation of information.

One way to provide such screens or displays is to provide a phone having two parts that are slidable in relation to one another, wherein for instance the upper part comprises at least one display.

Nevertheless, there is a demand to provide alternative solutions to the problem of presenting information on portable electronic devices.

### SUMMARY

The present invention is directed towards providing an alternative method and device for presenting information to a user.

According to an aspect of the present invention, there is provided an information presentation device for presentation of data information, the information presentation device comprising an information presentation unit arranged to present data information to a user, and a presentation controlling unit connected to the information presentation unit, said presentation controlling unit being arranged to control the presentation of the information on the information presentation unit in dependence of physical rotation around an axis of rotation of the information presentation device.

Said presentation controlling unit of the information presentation device may further be arranged to determine physical rotation around the axis of rotation of the information presentation device and arranged to provide the presentation of information in dependence of the determined rotation.

Said presentation controlling unit of the information presentation device may further be arranged to shift out information from the information presentation unit, and to shift in information to be information presentation unit in dependence of the determined physical rotation of the information presentation device.

Said information presentation unit of the information presentation device may further comprise a substantially rotation symmetric shape around the axis of rotation, and where the information presentation unit covers at least substantially the entire turn around the envelope surface of the rotation symmetric shape.

Said information presentation unit of the information presentation device may further be arranged to present a site in relation to the presented information, where information may be shifted out from the information presentation unit and shifted in to the information presentation unit, in dependence of the rotation of the information presentation device.

The position of the presented site on the information presentation unit may be changed in relation to the rotation of the information presentation device.

The information presentation device may further comprise a mobile phone.

According to another aspect of the present invention, there is provided a method for controlling an information presentation unit adapted to present information, comprising obtaining information to be presented on an information presentation unit, presenting information on the information presentation unit, detecting a rotational motion around an axis of rotation of an information presentation device, and providing the presented information on the information presentation unit in dependence of the detected rotational motion, such that information can be shifted out from the information presentation unit and shifted in to the information presentation unit.

It should be emphasized that the term “comprises/comprising” when being used in the specification is taken to specify the presence of the stated features, integers, steps or components but does not preclude the presence or addition of one or more other features, integers, steps or components or groups thereof.

### BRIEF DESCRIPTION OF THE DRAWINGS

In order to explain the invention and the advantages and features thereof in more detail, embodiments will be described below, references being made to the accompanying drawings, in which

FIG. 1 illustrates an information presentation device according to some embodiments of the present invention;

FIG. 2 illustrates a display controlling unit according to some embodiments of the present invention;

FIG. 3 illustrates an information presentation device according to some embodiments of the present invention;

FIG. 4 illustrates an upper, a middle and a lower panel, each presenting one view along an axis of rotation, A, and two views perpendicular to said axis or rotation, A, of an information presentation device, of which the left hand view shows the information presentation device from the left hand side and the right hand view shows the information presentation device from the right hand side; and

FIGS. 5A and 5B illustrate method steps of a flow chart according to at least some embodiments of the present invention.

### DETAILED DESCRIPTION

When presenting information of a display or a screen, especially when presenting list type information, for instance in the form of text information, the information presentation device according to a number of embodiments of the present provides a valuable tool, as an alternative to the displays and screens known today.

With reference to the figures as presented above, a few preferred embodiments of the present invention are now explained.

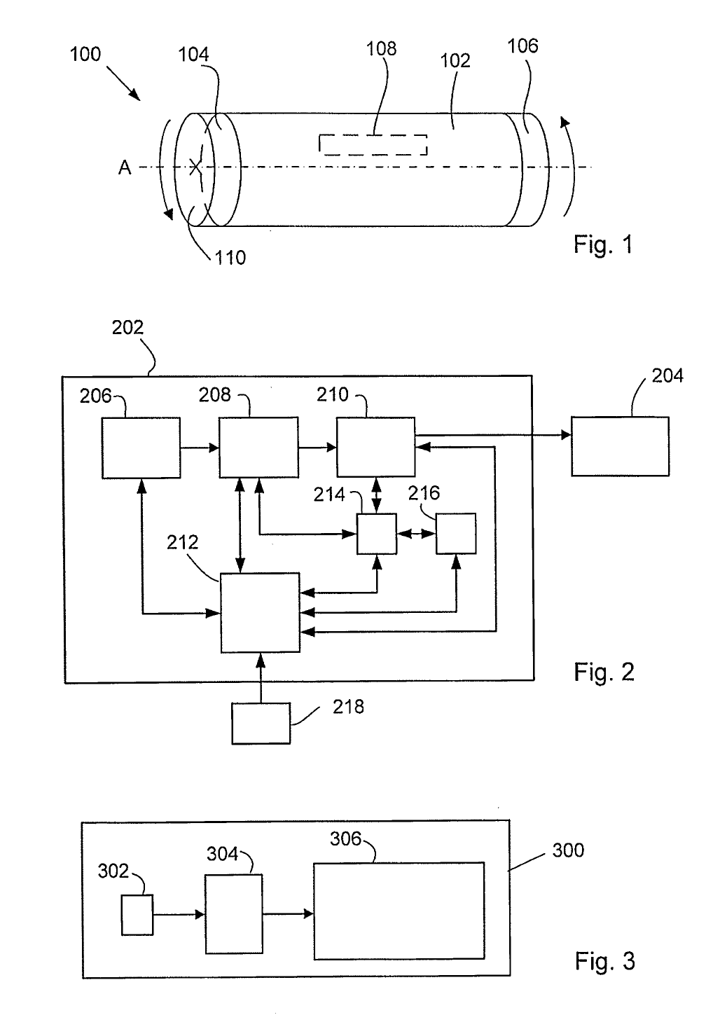

In FIG. 1 an information presentation device 100 is illustrated, which information presentation device also comprises an information presentation unit 102. The information presentation unit may be a display.

In addition, a user input unit and a grip area, marked as 104 and 106, respectively, may also be comprised in the information presentation device 100.

The user input unit may be realized as a push key, as a slidable key or switch, as a wheel or in any other way.

The user input unit 104 may also function as a grip area, and the grip area 106 may alternatively also comprise a user input unit.

A cursor area 108 may also be provided on the information presentation unit, as indicated in FIG. 1.

The information presentation device, viewed perpendicular to the axis of rotation is presented as 110.

The information presentation device is suitable for presenting list type information for which reason a rotation around an axis of rotation of the device is triggering an update of the information as presented on the display.

According to some embodiments, the information presentation unit covers the entire turn or at least substantially the entire turn of the information presentation device. For technical reasons it may be difficult to produce a display covering an entire turn, for which reason substantially the entire turn may be provided as an information presentation unit.

According to some preferred embodiments, the information presentation unit being a part of the information presentation device has a cylindrical shape, which information presentation unit may be realised in the form of a display, and may cover the entire turn and may therefore appear as to be endless when viewing the entire display.

Viewing the display from one side perpendicular to the axis of rotation, in case of a rotation symmetric information presentation device, information can be presented just as reading or viewing a list of information from a white paper sheet. However, since information has to be updated as the device is rotated new information may have to be imported to the displayed section of the list and old information may have to be exported from the displayed section of the list.

According to at least some embodiments of the present invention, an input and output longitudinal site parallel with the axis of rotation, is defined. The position of this site can be made to depend on rotation around the axis of rotation of the information presentation device.

List type data may be displayed on the information presentation unit. List type data comprises data that may be displayed as a list of items such as text, icons, figures, thumbnails, links, video clips, or the like.

The distance along the circumference of the information presentation unit, between two consecutive items in the list corresponds to the “line spacing” of the list, according to at least some embodiments of the present invention.

If rotation equals to or exceeds an angle of one line spacing, the position of the input/output site is updated, such that a new line will appear at one end of the displayed section of the list and one old line of the displayed section of the list can be shifted out of the displayed area.

With reference to FIG. 2 illustrating a display controlling device 202 connected to a display 204, one embodiment of a device for controlling the information displayed on the display is now presented.

Rotation around an axis of rotation may be detected by a rotation detection unit 206, which may be realised as a gravitation dependent unit that is arranged to detect rotation around an axis of rotation. In the case the information presentation device has an elongated shape the axis if typically the longitudinal axis.

An angle determining and evaluation unit 208 is provided after the rotation detection unit 206. The angle determining and evaluation unit, which in short may be called the angle unit, may determine the angle of rotation around the axis of rotation and evaluate whether any accumulated angle exceeds an angle of rotation that corresponds to the line spacing of the information as displayed on the display, or not.

The angle unit 208 is further connected to a display driver unit 210, which further may have a direct connection to the display 204, as presented in FIG. 2.

A memory unit 214 may also be provided in the display controlling device 202 for providing data of the information to be displayed on the display. This memory unit 214 may be connected to the angle unit 208 and to the display controlling unit 210.

In addition, a control unit 212 may be provided to control the function of the rotation detection unit 206, the angle determining and evaluation unit 208, the display controlling unit 210 and the memory unit 214. More over a transceiving unit 216 may also be provided and connected to the control unit 212 as well as to the memory unit 214.

According to at least some embodiments a user input unit 218 is also connected to the control unit 212 of the display controlling device 202. This user input unit 218 may be used to activate a method for presenting list type information, such as a list of items or the like, on a display, and to be used to confirm that data positioned within the cursor area 108 are to be selected for further activities. The user input unit may also be used to activate other display related functions.

FIG. 3 further illustrates an information presentation device 300 according to at least some embodiments of the present invention. The information presentation device 300, comprises a user input unit 302 connected to a display controlling unit 304, which further may be connected to an information presentation unit such as a display or a screen 306. According to at least some embodiments, the information presentation unit 306 covers the entire or substantially the entire envelope surface of the information presentation device 300, in the case of a rotation symmetrical shape of the information presentation device.

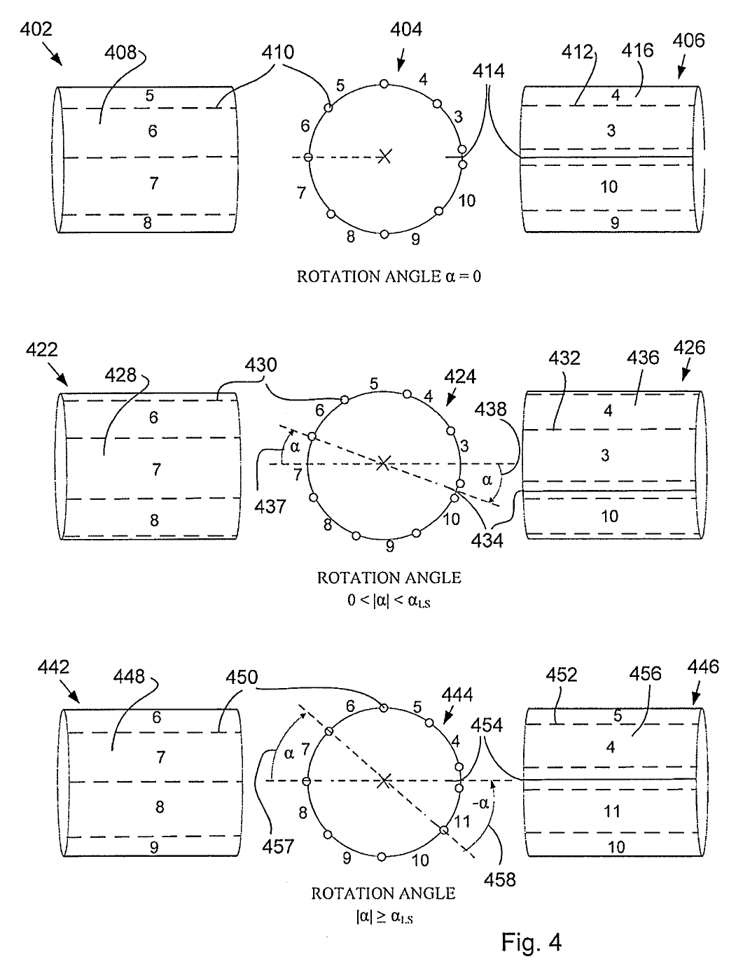

FIG. 4 illustrate a cylindrical information presentation device presented in three panels; an upper panel, a middle panel and a lower panel, where each panel presents the cylindrical information presentation device at one specific rotation angle, α. The cylindrical information presentation device is thus presented at three different rotation angles. The upper panel illustrates views of the information presentation device at a rotation angle α=0.

To the left is displayed a view 402 perpendicular to the longitudinal axis from the left, and to the right there is displayed a view 406 perpendicular to the longitudinal axis from the right. The dotted lines of the left 410 and right 412 views indicate line breaks, i.e. the spacing between two consecutive lines. The numbering 3, 4, 5, 6, 7, 8, 9, and 10 denote line information as being representative to list type information, of which items, icons, and thumbnails are only examples of a large variety of items that can be displayed on the information presentation unit.

In the centre of the upper panel there is illustrated an information presentation device 404 viewed essentially along the longitudinal axis. Here the line breaks are indicated with circles 410 separating the consecutive lines from one another.

The site for input and output (I/O) of line information 414 on the display is indicated on the left hand side of the centre representation and thus also appears on the right hand side view of the information presentation device 406. It should be emphasized that this site is merely a line at which the information as presented on the display may be shifted in and shifted out.

As the list type information is presented to be displayed from top and downwards on one side of the information presentation device that does not comprise the I/O site, the information as displayed near the I/O site is displayed upside down, as well as being discontinuous since the I/O site itself creates the context discontinuity.

The I/O site may not be clearly visible in case the information as displayed is presented such that the height of the display or screen, corresponds to an integer number of displayed item lines.

According to some embodiments of the present invention, the I/O site is a position at which information may be shifted out of the display and shifted in to the display, rather than being a physical hard ware display interruption.

Now, as the information presentation device is rotated by for instance a user holding the device in his or her hands and rolling the device to read or view further lines of list type items above or below the current view of the display, the rotation detection unit may detect rotation, which may start monitoring of the angle of rotation.

Rotation of the device enables a person to read or view the entire list material line by line. The updating of information is done not by updating the whole displayed information. The only piece of information that is necessary to update is the information presented around position of the I/O site. Since only two lines of list type data may have to be updated in order to move the I/O site one line spacing distance along the envelope surface, updating is quick. Moreover, the user will appreciate this by that the list type data will not jump on the display when reading or viewing the data when rolling or rotating the information presentation device. Instead the list type information appears to be fixed to the screen and therefore steady, which facilitates the reading by becoming less tiresome to a user's eyes when reading. This is in contrast to a normal screen, on which text jumps by one or more lines at a time when scrolling, which clearly becomes tiresome in the long run to a reader.

Now returning to FIG. 4 and the middle panel illustrating three views of an information presentation device at a non-zero rotation angle α. The rotation of the device is here smaller than the rotation angle corresponding to one line spacing. This angle is denoted α_{LS}.

As was described for the upper panel, to the left is displayed a view 422 perpendicular to the longitudinal axis viewed from the left, and to the right there is displayed a view 426 perpendicular to the longitudinal axis viewed from the right. Again the dotted lines on the left 430 and right 432 views indicate line breaks, which again are virtual line breaks between two consecutive lines. Thus the numbering 3, 4, 6, 7, 8, and 10 denote line information as being representative to list type information.

In the centre of the middle panel there is illustrated the information presentation device viewed nearly along the longitudinal axis. Here the line breaks are indicated with circles 430 separating the consecutive lines from one another.

In the centre display the angle α is clearly illustrated and shows how the whole information presentation device is rotated an angle α. The line spacing breaks as well as the lines themselves are thus also rotated an angle α along the envelope surface of the display of the information presentation device.

In the view 422 on the left hand side, it can therefore be seen that the lines 6, 7 and 8 have been rotated with respect to the position of the lines 6, 7 and 8 as displayed in the upper panel on the left hand side as shown in view 402.

Similarly, it can be seen the line breaks and the lines 3, 4 and 10 as displayed in the middle panel on the right hand side as shown in view 426 have been rotated with respect of the position as displayed in the upper panel of FIG. 4 on the right hand side view 406.

It is clearly visualised that the I/O site 434 of the display 436 is rotated along with the display a rotation angle α around the longitudinal axis. The I/O site is thus no longer centred on the right hand side view 426 of the middle panel.

The right hand side view 426 shows that for a rotation angle α that is smaller than a rotation angle that corresponds to a line spacing of the list type information, α_{LS} as presented on the display, the position of the I/O site is rotated along with the entire display and no updating of information on the display is performed.

Now, focusing on the lower panel of the three panels displaying an information presentation device at three different views, the information presentation device has been rotated an angle α that at least corresponds to the line spacing angle α_{LS}.

The left 442, right 446 and centre 444 views refer to different views of the information presentation device as explained above for the middle and upper panels.

In the centre view 444 is shown that the rotation angle α corresponds to the line spacing rotation angle α_{LS}, as the line spacing mark between lines 7 and 8 in view 442 has taken the position of the line spacing mark between lines 6 and 7, as shown in the upper panel, left hand side view 402.

The left hand side view 442 of the information presentation device in the lower panel thus presents further rotated lines, showing information on lines 6, 7, 8 and 9. The position of each of these lines therefore corresponds to the position of the lines 5, 6, 7, and 8 in the upper panel, left hand side view 402.

On the right hand side view 446, the position of the I/O site is now discussed. As the rotation angle of the information presentation device α, corresponds to the line spacing angle α_{LS}, a new line, line 11, of information is shifted in to the displayed area at the bottom of the displayed area. In addition, the first displayed line, line 3, is shifted out of the displayed area, bringing line 4 as the new first line of the displayed area. Together with the new line, line 11 being shifted in, the effect is that the I/O site is rotated an angle α in a direction opposite to an increasing angle α along the envelope surface. The angle of rotation of the I/O site in view 444 is therefore minus α, since α may either be a positive angle or a negative angle.

As the position of the input/output (I/O) site is rotated in a direction opposite to increasing angle α, the position on the display of the I/O site may be maintained in the centre of the display.

It should be clarified that the function of rotation of the I/O site may be switched off and again switched on. In a switched off mode, the position of the I/O site is not shifted and the information of the display may not be updated.

As the position of the I/O site is not rotated in the switched off mode, the I/O site can easily be rotated to the side of the display, being one example of the user presentation unit, that is directed away from the user holding the device, before switching on the information presentation device for updating of the display of said information presentation device.

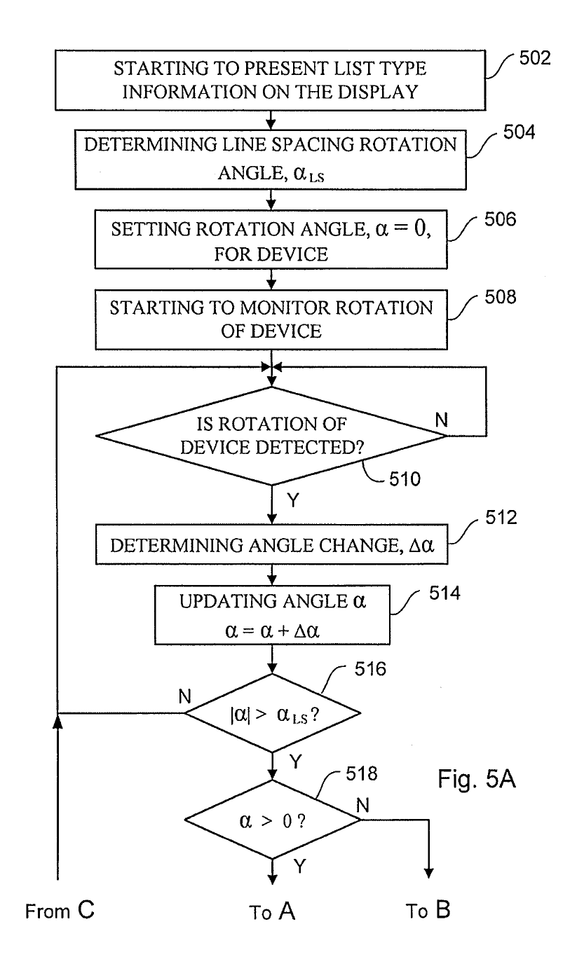

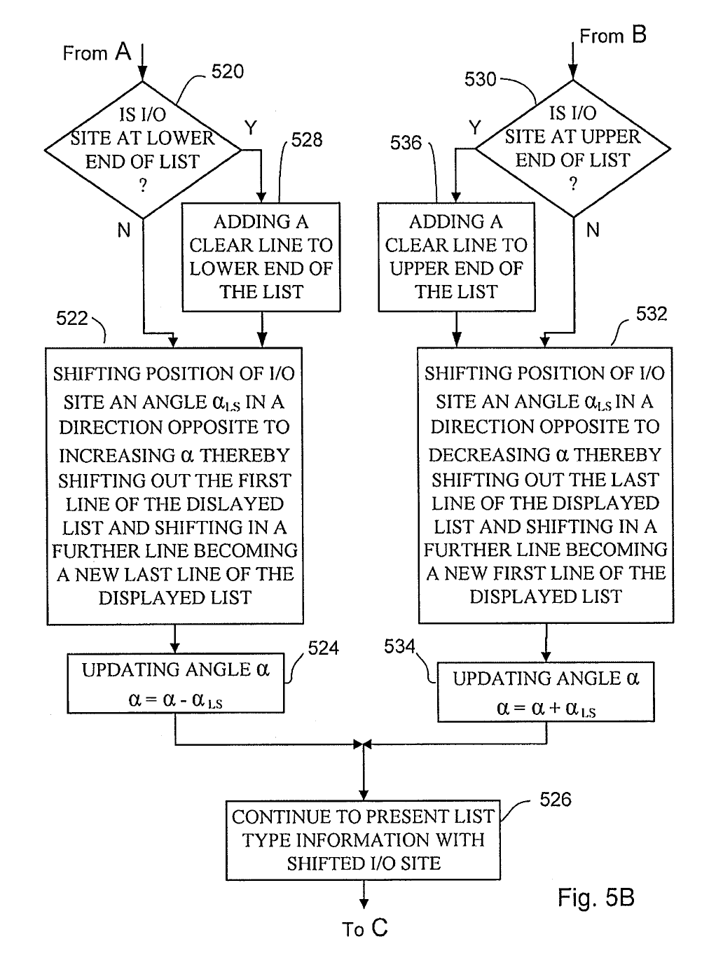

FIGS. 5A and 5B illustrate a method for updating of the position of the I/O site, which is described in more detail below.

According to at least some embodiments this method may start with step 502, starting to present list type information on an information presentation unit 102. Here the information presentation unit 102 comprises a display.

When presenting list type information, the rotation angle that corresponds to a line spacing distance along the envelop surface, α_{LS} of the information presentation device is now determined in step 504. This angle α_{LS} is thus the rotation angle that the rotation of one line around the longitudinal axis corresponds.

In the case the list type information comprises text type information, and is displayed with a small font size, the angle α_{LS} becomes relatively small, whereas in the case the font size is large, the angle α_{LS} becomes relatively large.

The following step may the step 506 of setting the rotation angle α=0, i.e. zero, for the information presentation device. The angle α is reset to zero in order to start from a well-defined angle value.

Monitoring of the rotation of the information presentation device is started by step 508. From this step and on, rotation of the device is thus monitored and updating of the information of the display may be performed in dependence of the rotation of the information presentation device around an axis of rotation.

Rotation of the device is detected in the step 510, “Is rotation of device detected?” In the case rotation is detected, the angle change, Δα, that is caused by the rotation is then determined. This is performed in step 512.

In case no angle rotation is detected in step 510, it is again determined in the following step whether a rotation is detected in the very same step, step 510, as shown in FIG. 5A.

If, however, a rotation actually is detected in step 510 and the rotation angle change determined in step 512, the angle alpha is updated at step 514, α=α+Δα.

Having updated the angle α, it is determined whether the updated rotation angle corresponds to the distance of a line spacing along the envelope surface of the device, and angle α_{LS}. This is performed in step 516 where it is determined whether the absolute value of the angle α is larger than the line spacing angle α_{LS}.

Since the information presentation device may be rotated around an axis of rotation in two directions, one being clockwise and the other being counter clockwise around an axis of rotation, it would not be enough to determine whether the information presentation device is rotated an angle that larger than the line spacing angle.

The information presentation device may equally well be rotated in the opposite direction such that the rotation angle α_{LS} becomes smaller than a negative line separation angle.

If the absolute value of the rotation angle α is not larger than the line spacing angle α_{LS}, the next step in the method is then detecting whether rotation of the device is detected in step 510.

In the case where the rotation angle is positive and larger than the line spacing angle α_{LS}, that is answering Y in step 518, the following step in the method is step 520, as illustrated in FIG. 5B, determining whether the I/O site is positioned at the lower end of entire list, or not.

A positive rotation angle change of the information presentation device is defined as the direction is which the device is rotated when reading from top and downwards of the list type information. Likewise, a negative rotation angle change is defined as the direction in which the device is rotated when reading the information from bottom and upwards.

As explained above, the I/O site is typically a site at which presented information may be shifted out and information to be presented may be shifted in.

The list type information to be displayed in the display, may commence with the top line of the entire list file. This top line equals to the upper end of the list. A corresponding bottom line of the entire list is thus the lower end of the list.

In step 520 it is determined whether the I/O site is positioned at the lower end of the entire list, or not. If the I/O site is not positioned at the lower end of the entire list, meaning that there is additional information to be switched in, the following step is the step at which the position of the I/O site is changed.

According to at least some embodiments, step 522 comprises shifting the position of the I/O site an angle α_{LS} in a direction towards decreasing α angle value. By shifting this I/O site the first line of the displayed list is shifted out. Also, a further line is shifted in becoming a new last line of the displayed list.

Returning to the information presentation device as displayed at three different rotation angles, it is illustrated when comparing the upper panel and the lower panel, that the first line, being line 3, of displayed list of the right hand side view 406 of the upper panel, is switched out and line 11 is shifted in to the displayed area, as illustrated in the lower panel in the right hand side view 446 of FIG. 4.

Having shifted the I/O site position, the angle α is updated in step 524, performing α=α−α_{LS}. After the alpha α is updated the next step to execute may be step 526, continuing to present list type information, but now with a shifted I/O site position.

Subsequent to presenting the information on the display with an updated I/O site position, step 510 is performed by determining whether rotation of the device is detected or not.

Returning to FIG. 5B and the case in which the I/O site is positioned at the lower end of the list, there is no additional information to be switched in to the displayed. When the question in step 520 is answered by a “Y”, the following step may therefore be step 528 of adding a clear line to the lower end of the list. The list of items is thus prolonged with one clear line or item from below. This is performed in order to avoid presenting the I/O site to the user rotating the information presentation device in step 526, as repetitive shifting of information else could risk displaying the I/O site to the user.

It should be clarified that the clear line is added to the lower end of the list itself, rather than to the information as presented on the information presentation device. The clear line is therefore displayed in the displayed area, after shifting of the I/O site has been performed.

In the case the information presentation device is rotated, by for instance a user, in the direction for which the angle α is negative, that is when rolling or rotating the device around an axis of rotation from the bottom of the display area to the top of the display area, the angle change is negative and the accumulated angle α may become negative in step 518.

Following the alternative B to FIG. 5B, the next step to the performed is determining whether the I/O site is positioned at the upper end of the entire list, in step 530.

In case the I/O site is already positioned at the upper end of the list, as determined in step 530, the following step is adding a clear line to the upper end of the list, in step 536. As described in connection to step 528, the clear line as added to the list itself. The clear line is then shifted into the displayed area in step 532, when the information is updated around the I/O site, in the way as earlier described.

However, if it is determined that the I/O site is not positioned at the upper end of the entire list, the following step is step 532 at which shifting of the I/O site is performed. In this step, shifting is performed in a direction opposite to the direction as described in step 522. In step 532 the I/O site is shifted an angle α_{LS} in a direction opposite to the direction of decreasing angle α. The absolute value of the angle α is thus decreased. The last line on the display is thus shifted out. In addition, shifting in of a further line that is becoming a new first line on the display is hence also performed, in step 532.

Having performed the shifting of the I/O position, the angle α is updated in step 534 by updating the angle α by setting α=α+α_{LS}.

After the alpha α is updated the following step is to continue presenting the list type information with the shifted I/O site in step 526, as illustrated in FIG. 5B. As explained above, subsequent to step 526 it is again determined whether rotation of the device is detected, or not in step 510, as illustrated in FIG. 5A.

According to an alternative embodiment of the present invention, the position of the I/O site may be shifted when the absolute value of the angle of rotation is larger than a part of a full turn, for instance a quarter of a turn.

Moreover, it is obvious that the information presentation device can be turned and rotated in any direction, for which reason list displayed close to the I/O site may be turned around to be displayed from top and downwards. The opposite side of the information presentation device, which now does not comprise the I/O site, is then displayed upside down, as only one side at a time may be displayed from top and downwards.

According to at least some embodiments of the present invention, the position of the cursor area on the information presentation unit, is also dependent on the rotation of the information presentation device. The cursor area may be shifted in a similar way as the I/O site is shifted in position. The cursor area is typically shifted in the same direction as the I/O is shifted.

As the cursor area is subjected to shifting, the cursor area is preferably positioned on a side of the information presentation device opposite to the I/O site.

The I/O site is shifted whenever the absolute value of the rotation angle alpha exceeds alpha LS. In the case of the I/O the alpha LS may be the angle corresponding to a singular pixel distance around the circumference of the information presentation device. In the case of the I/O the alpha LS may alternatively related to the distance between two consecutive items displayed on the information presentation unit.

In the case of the cursor area, the cursor area is typically shifted if the absolute value of the angle exceeds the distance between two consecutive pixels along the circumference of the information presentation device. This has the effect that the cursor area is experienced to move in relation to the information presentation unit, upon rotation of the information presentation device.

The information presentation device can thus easily be turned again such that displayed information is shown without the presenting the I/O site on the viewed side.

In addition, the information presentation device function as described herein may be inactivated or switched off as indicated above, possibly for presentation of material different from list type material on the display. In a switched off mode, updating of the screen will thus not be performed, as the device will not respond to rotation around any axes.

It is emphasized that the present invention can be varied in many ways, of which the embodiments as presented are just a few examples. These embodiments are hence non-limiting. The scope of the present invention is however, limited by the subsequently following claims.

The information as presented on the information presentation unit may be updated on a more continuous basis, as compared to what has been described above. The line spacing distance may be defined as the distance between two consecutive pixels along the circumference or the envelope surface of information presentation device. By shifting information in and out at the I/O site per line of pixels, a “smooth scroll” experience may be provided to a person towards whom the I/O-side of the information presentation device is directed.

It is thus easy to understand that the embodiments come with a multiple of advantages of which a few are:

Updating of the display is limited to a small portion at a time

List type information will appear as fixed to the display and will not jump as updating of information is performed, which is appreciated by a user since this updating will not be experienced as tiresome for a user's eyes.

1. An information presentation device for presentation of data information, the information presentation device comprising:
an information presentation unit arranged to present data information to a user, and
a presentation controlling unit connected to the information presentation unit, said presentation controlling unit being arranged to control the presentation of the information on the information presentation unit in dependence of physical rotation around an axis of rotation of the information presentation device.

2. The information presentation device according to claim 1, wherein the presentation controlling unit further is arranged to determine physical rotation around the axis of rotation of the information presentation device and arranged to provide the presentation of information in dependence of the determined rotation.

3. The information presentation device according to claim 2, wherein the presentation controlling unit further is arranged to shift out information from the information presentation unit, and to shift in information to be information presentation unit in dependence of the determined physical rotation of the information presentation device.

4. The information presentation device according to claim 3, wherein the information presentation unit comprises a substantially rotation symmetric shape around the axis of rotation, and where the information presentation unit covers at least substantially the entire turn around the envelope surface of the rotation symmetric shape.

5. The information presentation device according to claim 3, wherein the information presentation unit is arranged to present a site in relation to the presented information, where information may be shifted out from the information presentation unit and shifted in to the information presentation unit, in dependence of the rotation of the information presentation device.

6. The information presentation device according to claim 5, wherein the position of the presented site on the information presentation unit may be changed in relation to the rotation of the information presentation device.

7. The information presentation device according to claim 1, wherein said information presentation device is comprised in a mobile phone.

8. A method for controlling an information presentation unit adapted to present information, comprising the steps of:
obtaining information to be presented on an information presentation unit,
presenting information on the information presentation unit,
detecting a rotational motion around an axis of rotation of an information presentation device, and
providing the presented information on the information presentation unit in dependence of the detected rotational motion, such that information can be shifted out from the information presentation unit and shifted in to the information presentation unit.
